(19) United States
(12) Patent Application Publication
(10) Pub. No.: US 2018/0128322 A1
(43) Pub. Date: May 10, 2018

(54) Connecting Arrangement for Connecting a Shaft to a Component

(71) Applicant: Neumayer Tekfor Engineering GmbH, Hausach (DE)

(72) Inventor: Thomas ETZOLD, Offenburg (DE)

(21) Appl. No.: 15/803,384

(22) Filed: Nov. 3, 2017

(30) Foreign Application Priority Data
Nov. 4, 2016 (DE) 10 2016 013 076.8

(51) Int. Cl. F16D 1/116; F16B 9/02; F16B 21/02

(52) U.S. Cl. CPC F16D 1/116; F16D 2001/103; F16B 21/02; F16B 9/023

(57) ABSTRACT

The invention relates to a connecting arrangement for connecting a shaft to a component. A tapered outer surface of an inner ring and a tapered inner surface of an outer ring are configured in a manner corresponding to each other. The outer ring surrounds the inner ring. A union nut surrounds the outer ring and the threaded piece. The union nut has an internal thread and the threaded piece has an external thread, wherein the internal and the external threads are configured in a manner corresponding to each other.

### CROSS REFERENCE TO RELATED APPLICATIONS

This application claims priority under 35 U.S.C. § 119 from German Patent Application No. 10 2016 013 076.8, filed Nov. 4, 2016, the entirety of which is expressly incorporated by reference herein.

### BACKGROUND AND SUMMARY OF THE INVENTION

The present invention relates to a connecting arrangement for connecting a shaft to a component.

A connecting arrangement between a shaft journal and a joint part as the component is disclosed, for example, by DE 10 2007 038 878 A1 or EP 1 519 063 A2. A union nut and a shaft nut, which are respectively connected to the joint part and to the shaft journal, are screwed to each other.

DE 1 185 424 presents a connecting arrangement of a shaft to a nut, wherein an outer ring and an inner ring are used. The two rings have corresponding tapered inner and outer surfaces. A clamping sleeve with tapered or conical contours is disclosed by DE 10 2005 022 711 B3.

The connection between a shaft and a receiving part for receiving the shaft can be understood from DE 1 943 790 A. The receiving part here has a threaded portion and segments with a frustoconical surface. The connection is produced via a sleeve, which is screwed onto the threaded portion, and a ring with a frustoconical inner surface, the ring being located between the sleeve and the segments. A receiving part that is complicated to manufacture is therefore required for this connection.

It is the object of the invention to propose an alternative connecting arrangement to the prior art.

The invention achieves the object with a connecting arrangement for connecting a shaft to a component. The connection refers here, for example, to the connection of a component to the shaft journal of a shaft. The component is, for example, a joint part. In one variant, the connecting arrangement is connected indirectly or directly to a motor and/or, in an exemplary embodiment, is part of the drivetrain of a vehicle.

The connecting device has an inner ring, an outer ring, a union nut and a threaded piece. The inner ring has a tapered outer surface, and the outer ring has a tapered inner surface. The tapered outer surface of the inner ring and the tapered inner surface of the outer ring are configured in a manner corresponding to each other. The outer ring and the inner ring are configured and coordinated with each other in such a manner that the outer ring at least partially surrounds the inner ring. The union nut and the outer ring are configured and coordinated with each other in such a manner that the union nut at least partially surrounds the outer ring. The union nut and the threaded piece are configured and coordinated with each other in such a manner that the union nut at least partially surrounds the threaded piece. Furthermore, the union nut has an internal thread and the threaded piece has an external thread. Finally, the internal thread of the union nut and the external thread of the threaded piece are configured in a manner corresponding to each other.

The connecting arrangement permits the connection of a shaft or a shaft journal as end region of a shaft to a component, which is, for example, a joint part. Axial securing is produced here between shaft and component. An inner and an outer ring each have a tapered outer surface, wherein the two tapered outer surfaces are configured in a manner corresponding to each other, i.e., they have, for example, mutually corresponding pitches. The two rings are at least partially surrounded by a union nut. The union nut is connected, preferably in a reversibly releasable manner, to a threaded piece via corresponding threads. In one refinement, the inner ring serves for a frictionally locking connection to the shaft. For the connection, the shaft has a circular-cylindrical portion, preferably at least in the region in which the inner ring rests.

In one refinement, the threaded piece and the outer ring are configured and coordinated with each other in such a manner that the threaded piece at least partially surrounds the outer ring. In a further refinement, it is provided that the union nut, the threaded piece and the outer ring are configured and coordinated with one other in such a manner that the threaded piece is at least partially arranged between—in the radial direction—the union nut and the outer ring. If the threaded piece is located in the radial direction between the outer ring and the union nut, the outer ring is located in the radial direction between the inner ring and the threaded piece.

In one refinement, the threaded piece serves to the effect that, in the case of a frictionally locking connection that is produced in particular between the inner ring and the shaft, substantially axial forces are transmitted to the shaft. Consequently, substantially no stress concentrations occur.

In the various refinements, surrounding relates in particular to the relative arrangement of the elements under consideration in the radial direction, the arrangement therefore generally also being associated with an at least partial overlap of the elements of the connecting arrangement. In addition, the surrounding can be indirect or direct, and therefore, depending on the refinement, at least one further element is still located between two elements, of which the one surrounds the other. Furthermore, surrounding relates to the fitted state, i.e., to the state in which the connection is produced between the shaft and the component.

In one refinement, at least some of the components of the connecting device are configured to be substantially rotationally symmetrical.

In one refinement, it is provided that the union nut, the threaded piece, the outer ring and the inner ring are configured and coordinated with one another in such a manner that, during the production of a screw connection to the threaded piece, the union nut moves the outer ring axially along a longitudinal axis in the direction of the threaded piece. In this refinement, the union nut therefore pushes the outer ring in the direction of the threaded piece when the union nut is screwed to the threaded piece. In one refinement, the longitudinal axis here is the axis of symmetry of some of the elements of the connecting arrangement, and/or, in a further refinement, is a longitudinal axis of the shaft and/or of the component.

In one refinement, the movement of the outer ring is therefore also connected to the fact that the tapered outer surfaces of the outer and of the inner ring are wedged together such that the outer ring is therefore displaced relative to the inner ring so that the outer ring overlaps the inner ring in the radial direction (i.e., in a direction perpendicular to the longitudinal axis which is, for example, the longitudinal axis of the shaft). The inner ring is preferably configured here—for example via a coefficient of friction of a supporting side facing the shaft—in such a manner that the inner ring essentially does not move, and therefore the outer ring can thus be pushed onto the inner ring.

In one refinement, the threaded piece and the inner ring are configured in such a manner, and the inner ring is preferably dimensioned in such a manner, that the threaded piece limits a movement of the inner ring in the direction of the threaded piece. In one refinement, the inner ring therefore abuts the threaded piece, and therefore a further movement of the inner ring in the direction of the threaded piece is prevented.

One refinement includes the fact that the inner ring has an inner side, and that the inner side of the inner ring is configured for a—indirect or direct—contacting of the shaft.

In one refinement, it is provided that the threaded piece has an inner side, and that the inner side of the threaded piece is configured for contacting of the shaft and/or of the component. In one refinement, the threaded piece is configured and coordinated with the shaft in such a manner that the inner side of the threaded piece rests on the shaft in the mounted state. In one refinement, the inner side of the threaded piece rests only on the shaft and not on the component. In one refinement, the threaded piece rests here on the outer ring. In an alternative refinement, there is also a clearance between the threaded piece and the outer ring.

One refinement includes the fact that the threaded piece is configured and coordinated with the shaft and the component in such a manner that there is a clearance fit in each case between the inner side of the threaded piece and the shaft and between the inner side of the threaded piece and the component. A clearance fit is a fit in the form of a dimensional specification for two paired parts, in which, between the parts, there is still a movement clearance, referred to as clearance, for movement of the parts counter to each other.

In one refinement, it is provided that the threaded piece is configured and coordinated with the component in such a manner that the inner side of the threaded piece and the component have a clearance fit between each other. The effect achieved by the clearance fit is that there is rotatory decoupling between the threaded piece and the component. The threaded part that serves for the connection between shaft and component and that is screwed to the union nut therefore does not experience any torque from the threaded piece.

In one refinement, it is provided that the threaded piece is configured and coordinated with the shaft in such a manner that the inner side of the threaded piece and the shaft have a clearance fit between each other.

One refinement includes the fact that the threaded piece has a recess for partially receiving a securing ring. A securing ring or else grooved ring serves in general for axially securing elements against one another. A securing ring can be realized, for example, by means of a retaining ring or a snap ring. In one refinement, the component also has a recess, and therefore the securing ring is located between the securing ring recess of the threaded piece and the securing ring recess of the component. In one refinement, the securing ring recess of the threaded piece is located along a longitudinal axis outside the axial region which is covered by the union nut. Consequently, the recess, by way of example, is mounted axially in front of the union nut.

In one refinement, it is provided that the outer ring has a first portion and a second portion along a longitudinal axis. In one refinement, the outer ring, the union nut and the threaded piece are configured and coordinated with one another in such a manner that the threaded piece is arranged in the region of the second portion between the outer ring and the union nut.

One refinement includes the fact that the first portion of the outer ring has a larger outer radius than the second portion of the outer ring. In one refinement, this refinement preferably serves for the fact that the second portion, as part of the outer ring, is located radially below the threaded piece, at least in the mounted state in which the union nut is screwed to the threaded piece. The first portion that projects radially outward further by means of its outer diameter is used, in one refinement, in order for the union nut to be able to act on the outer ring and, as a result, to move the latter during the screwing.

In one refinement, the outer ring and the inner ring are arranged in such a manner that the tapered outer surface of the inner ring and the tapered inner surface of the outer ring converge from the threaded piece in the direction of the longitudinal axis.

In one refinement, it is provided that the outer ring has a higher modulus of elasticity than the inner ring. The modulus of elasticity is a material characteristic which describes the behavior of a body upon deformation. A higher value signifies a greater resistance of a material to elastic deformation. Insofar as the outer ring is more stable because of its modulus of elasticity than the inner ring, in one refinement, during the production of the connection and during the sliding of the outer ring relative to the inner ring, the diameter of the inner ring, primarily, becomes thinner. By this means, the inner ring exerts a surface pressure on the shaft located radially below it. A frictional connection is therefore produced between inner ring and shaft.

One refinement includes the fact that the outer ring has a reinforcement. A reinforcement or else armoring here is a strengthening of the outer ring by means of a further object, which here has in particular a higher modulus of elasticity, in order therefore to overall increase the modulus of elasticity of the outer ring in relation to the inner ring. In one refinement, the reinforcement has a lower specific weight than the outer ring, and therefore a weight reduction arises by means of the reinforcement. In one refinement, the reinforcement or, more precisely, the component serving for the reinforcement is composed of carbon fiber.

In one refinement, it is provided that the threaded piece has a first cup-like portion and a second cup-like portion. The first cup-like portion at least partially surrounds the component, and the second cup-like portion at least partially surrounds the outer and/or inner ring. The cup-like portions have a continuous recess, through which at least the shaft projects. In one refinement, the bottoms—which are provided with the recess—of the cup-like portions lie opposite each other or are formed by the same part of the threaded piece.

One refinement includes the fact that the first cup-like portion and the second cup-like portion have different inner diameters. In one refinement, the second cup-like portion which surrounds the outer ring and therefore preferably also the shaft has a larger inner diameter than the first cup-like portion. The inner diameters refers here in each case to the inner side of the border which forms the cup.

In one refinement, it is provided that the union nut has, on an end side, an end portion with a recess. The inner diameter of the recess of the end portion is smaller here than an inner diameter of the internal thread of the union nut. The union nut therefore has, on the end side, a radially inwardly protruding portion which, in one refinement, has a continuous recess at least for passage of the shaft.

One refinement includes the fact that the outer ring has a first portion, a second portion and a third portion along a longitudinal axis. In this case, the first portion lies between the second portion and the third portion along the longitudinal axis.

In one refinement, it is provided that the union nut and the outer ring are configured and coordinated with each another in such a manner that the third portion of the outer ring projects beyond the union nut in the axial direction, which faces away from the threaded piece. The radial extent or position of the elements or the constituents thereof relates here in particular to the mounted state.

In one refinement, it is provided in particular that the first portion of the outer ring is configured in such a manner that the union nut has an engagement surface or operative surface via which the union nut moves the outer ring in the direction of the threaded piece during the operation of screwing together union nut and threaded piece. Therefore, one refinement makes provision for the first portion to form an end portion of the outer ring. In an alternative refinement, the first portion projects over the third portion in the radial direction. The third portion then forms an end portion of the outer ring.

One refinement contains the fact that the third portion of the outer ring has a securing ring recess for a securing ring. In one refinement, the securing ring recess is located on a side facing away from the longitudinal axis.

In one refinement, the securing ring recess is located in particular in that region of the third portion of the outer ring which, as seen from the threaded piece, projects beyond the union nut, i.e. in a direction which faces away from the threaded piece.

In one refinement, it is provided that the outer ring, the securing ring in the securing ring recess of the third portion and the union nut are configured and coordinated with each other in such a manner that the union nut and the outer ring are secured axially against each other along the longitudinal axis. In one refinement, the first portion of the outer ring is additionally also configured in such a manner that the union nut is fixed axially with its end portion between the first portion and the securing ring.

One refinement contains the fact that the outer ring and the union nut are configured and coordinated with each other in such a manner that an outer diameter of the third portion is smaller than the inner diameter of the recess of the end portion of the union nut. This refinement permits the third portion to project beyond the union nut. In a further refinement, this refinement is connected to the fact that the first portion has a larger outer diameter than the third portion. This refinement makes it possible, for example, for the union nut to move the outer ring in the direction of the threaded piece during the screwing.

In one refinement, it is provided that the outer ring and the union nut are configured and coordinated with each other in such a manner that, in the region of the recess of the end portion of the union nut, a seal is located between the union nut and the third portion of the outer ring. In one refinement, the discussed seal is located in the axial direction between the first portion of the outer ring and the securing ring in the securing ring recess of the third portion.

In one refinement, it is provided that the third portion of the outer ring has a seal recess for a seal. In one refinement, the seal recess is located on a side of the third portion facing the shaft and therefore in the region of a supporting surface of the outer ring.

One refinement includes the fact that the inner ring and the threaded piece are configured as a single part. This refinement simplifies the assembly of the connecting arrangement and also removal since there are fewer parts.

In one refinement, it is provided that the inner ring and the threaded piece are configured as a single part, and that the inner ring, the threaded piece and the outer ring are configured and coordinated with each other in such a manner that the outer ring is at least partially situated between the inner ring and that region of the threaded piece which bears the outer thread of the threaded piece. In one refinement, the inner ring and the threaded piece enclose a chamber which is U-shaped in section and into which the outer ring projects.

One refinement includes the fact that the threaded piece has a recess for at least partially receiving a seal. In one refinement, this seal serves to seal the region between threaded piece and shaft or between threaded piece and component.

In one refinement, it is provided that the inner ring has a plurality of circumferentially arranged segments which are separated from one another by longitudinal recesses along the longitudinal axis. The segments make it possible to apply high clamping forces, wherein the supporting effect in the form of plastic deformation of the inner ring is avoided.

One refinement includes the fact that the shaft and the component are configured and coordinated with each other in such a manner that the shaft can be at least partially introduced into the component. In this refinement, the shaft is pushed into the correspondingly configured component.

In one refinement, it is provided that the component has splines for connecting to the shaft. The splines serve here for fixing component and shaft to each other and also for producing a torque flux between component and shaft.

Other objects, advantages and novel features of the present invention will become apparent from the following detailed description of one or more preferred embodiments when considered in conjunction with the accompanying drawings.

### BRIEF DESCRIPTION OF THE DRAWINGS

Specifically, there are a multiplicity of possibilities of configuring and developing the device according to the invention. Reference is made in this respect first to the patent claims following patent claim 1 and secondly to the description below of exemplary embodiments in conjunction with the drawing, in which:

FIG. 1 shows a sectioned three-dimensional illustration of a first variant of a connecting arrangement with a component and part of a shaft,

FIG. 2 shows part of a section through a second variant of a connecting arrangement with component and shaft,

FIG. 3 shows a section through a third variant of a connecting arrangement with a component and part of a shaft, and

FIG. 4 shows a sectioned three-dimensional illustration of the first variant of the connecting arrangement only with the component and without the shaft.

### DETAILED DESCRIPTION OF THE DRAWINGS

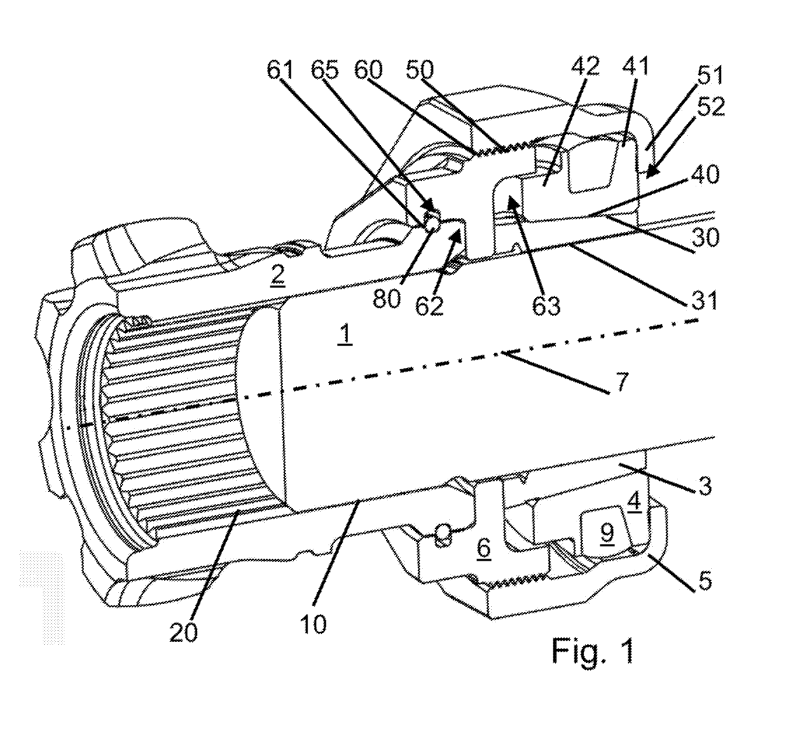

FIG. 1 shows a first variant of the connecting arrangement. The shaft 1 is introduced here into a recess of a component 2. In the example shown, the component 2 is part of a joint. The component 2 and the shaft 1 are connected to each other for conjoint rotation via corresponding splines 20, 10. The elements which ensure the axial fixing of the shaft 1 in relation to the component 2 are the inner ring 3, the outer ring 4, the union nut 5 and the threaded piece 6. The threaded piece 6 has a clearance fit here with respect to the component 2, and therefore the two can rotate relative to each other. The threaded piece 6 sits on the other side on the shaft 1, against which the inner ring 3 is also pressed.

In the radial direction, the elements are arranged, as seen from the supporting region of the inner ring 3 on the shaft 1, as follows: first of all the inner ring 3, over which the outer ring 4 is arranged. The outer ring 4 is partially surrounded by the threaded piece 6 and is partially directly adjacent to the union nut 5. The threaded piece 6 is in turn surrounded by the union nut 5.

The inner ring 3 has a tapered or conical outer surface 30 which corresponds to a tapered inner surface 40 of the outer ring 4. Furthermore, the inner ring 3 has an inner surface 31 which is configured for the contacting of the shaft 1. For example, the inner surface 31 is configured in such a manner that it has a coefficient of friction sufficiently high for a connection. Furthermore, the inner ring 3 is configured in such a manner that the inner ring 3 is caused by its axial length to butt against the threaded piece 6 if the mounted state is present—as illustrated in FIG. 1. An incision on the inner side 30 of the ring 3 can also be seen. This is the region from which the segments, to be discussed below, of the inner ring 3 branch.

In the refinement shown, the outer ring 4 has a first portion 41 and a second portion 42 on the outer side opposite the inner surface 40. The second portion 42 here has such an outer diameter that the second portion 42 fits between the threaded piece 6 and the inner ring 3. The first portion 41 has a larger outer radius and is located axially along the longitudinal axis 7 of the connecting arrangement or of the shaft 7 and of the component 2 between the end side of the threaded piece 6 and an inner side of the end portion 51 of the union nut 5. In order to increase the modulus of elasticity of the outer ring 4 in relation to that of the inner ring 3 and in order to reduce the weight of the outer ring 4, the outer ring 4 has a reinforcement 9.

The threaded piece 6 has an external thread 60 which is configured in a manner corresponding to the internal thread 50 of the union nut 5, and therefore threaded piece 6 and union nut 5 can be screwed reversibly to each other. Furthermore, the threaded piece 6 has two cup-like portions 62, 63 which each split a common base with a continuous recess. The first cup-like portion 62 here surrounds the component 2 and the second cup-like portion surrounds the arrangement consisting of the inner ring 3 and the outer ring 4, and therefore also the shaft 1. The outer side of the lateral border of the first cup-like portion 62 has a multiedge shape. A recess 65 for a securing ring 80 which likewise rests here in a recess of the component 2 is located on the inner side of the first cup-like portion 62 and therefore also on the inner side 61 of the threaded piece 6. The securing ring 80 secures the component 2 and the threaded piece 6 axially in relation to each other. The second cup-like portion 63 has the external thread 60 on the outer side of the lateral border.

The union nut 5 has the internal thread 50 and the end portion 51, in which a continuous recess 52 is located. The shaft 1 is guided through the recess 52. The union nut 5 in total surrounds the inner ring 3, the outer ring 4 and part of the threaded piece 6, namely at least the second cup-like portion 63.

If the union nut 5 is screwed on the threaded piece 6, the inner side of the end side 51 of the union nut 5 acts on the first portion 41 of the outer ring 4 and moves the latter axially along the longitudinal axis 7 in the direction of the threaded piece 6. The tapered outer surface 30 of the inner ring 3 and the tapered inner surface 40 of the outer ring 4 are arranged here with respect to each other in such a manner that the tapers or cones are directed counter to each other. The outer ring 4 is therefore pushed here radially outward on the inner ring 3 since the region of the inner ring 3 with the larger outer diameter faces the threaded piece 6. In addition, the second portion 42 of the outer ring 4 is also pushed under the border of the second cup-like portion 63 of the threaded piece 6. By means of the screwing, the outer ring 4 exerts an axial force on the inner ring 3 which is therefore fastened axially in relation to the shaft 1.

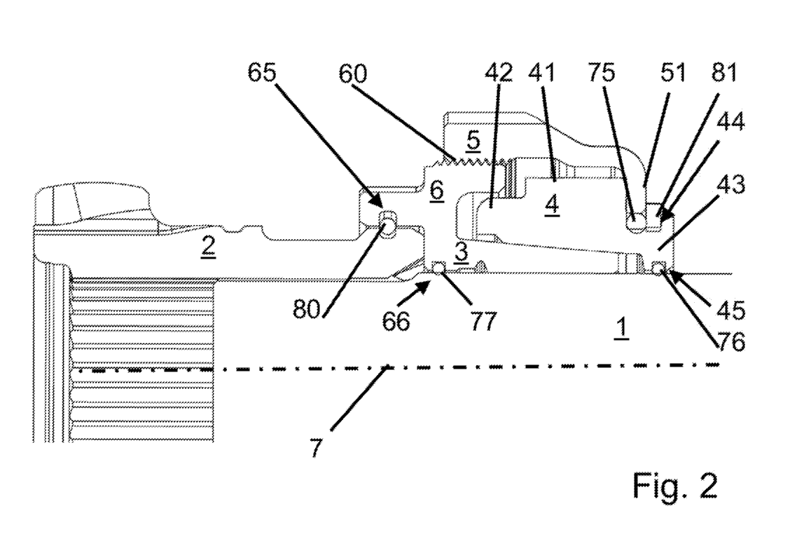

The variant of the connecting arrangement of FIG. 2 is similar to the variant of FIG. 1, and therefore only the differences are described here. In further refinements (not illustrated here), the differences are combined separately from one another with the variant of FIG. 1.

The threaded piece 6 and the inner ring 3 are configured as a single part here, and therefore the side edge of the threaded piece 6, which side edge bears the external thread 60, and the inner ring 3 are connected via a common base and have a U-shape, into which the outer ring 4 projects. This refinement means that fewer components are affected during installation and removal. Furthermore, the threaded piece 6 or the unit consisting of threaded piece 6 and inner ring 3 has a further recess 66 in which a seal 77, which is configured here as a sealing ring, is located.

In the refinement shown, the outer ring 4 has three portions, wherein the first portion 41 is arranged axially along the longitudinal axis 7 between the second portion 42 and the third portion 43. The first portion 41 carries out the task here (as in the variant of FIG. 1) that the union nut 5 can move the outer ring 4 in the direction of the threaded piece 6 via said first portion during the screwing. In an alternative refinement (cf. FIG. 1), the threaded piece 6 and the inner ring 3 are separate components. The third portion 43 projects beyond the union nut 5—as seen from the threaded piece. This has the purpose that a securing ring 81, which is located in a securing ring recess 44 of the third portion 43, secures the union nut 5 axially in relation to the outer ring 4. The union nut 5 therefore cannot be unscrewed from the threaded piece 6. In this connection, the end portion 51 of the union nut 5 is fixed in the securing ring recess 44 axially between the first portion 41 of the outer ring 4 and the securing ring 81.

As an addition, a sealing ring as seal 75 is also situated between the third portion 43 and the inner side of the recess of the end portion 81. A further sealing element 76—for example in the form of a sealing ring—is additionally arranged here in an associated recess 45 of the third portion 43 between the lower side of the outer ring 4 and the shaft 1.

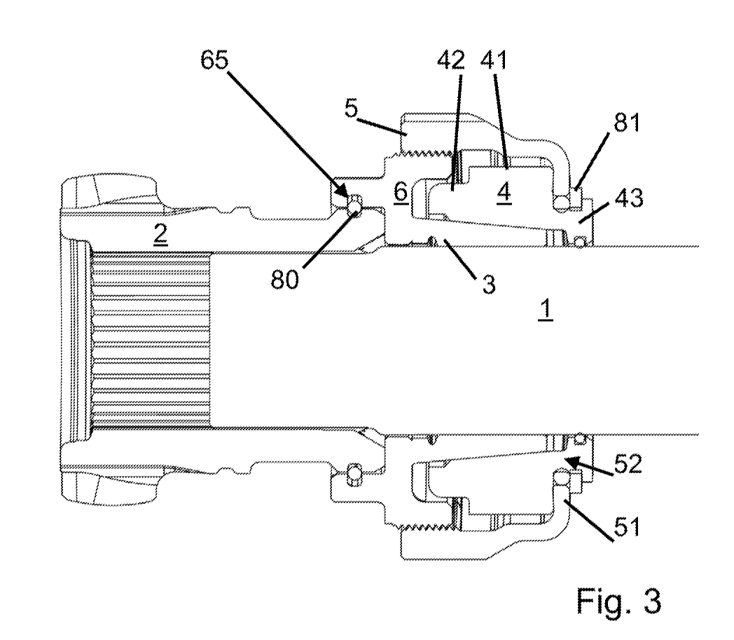

The third variant of FIG. 3 and the second variant of FIG. 2 of the connecting arrangement differ from each other in that the third variant does not have a recess for a sealing element in the region of the threaded piece 6.

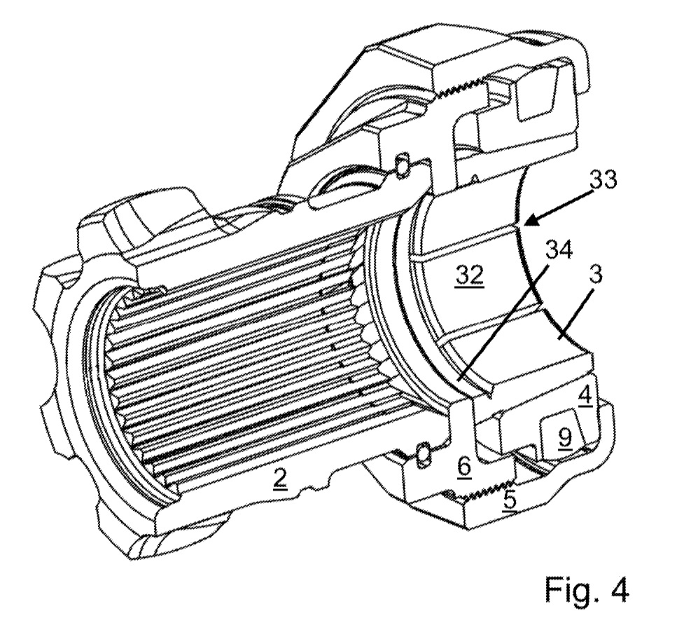

FIG. 4 shows the variant of FIG. 1 without the shaft.

It can be seen that the inner ring 3 consists of a plurality of segments 32 between which a recess 33 is in each case located in an encircling manner and which all emerge from a common, radially encircling base portion 34. The radially encircling groove which is located between the base portion 34 and the segments 32 can also be seen here. The segments 32 make it possible to exert high clamping forces on the shaft without a supporting effect occurring at the inner ring 3.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A connecting arrangement for connecting a shaft to a component, comprising:
an inner ring;
an outer ring;
a union nut; and
a threaded piece,
wherein the inner ring has a tapered outer surface,
wherein the outer ring has a tapered inner surface,
wherein the tapered outer surface of the inner ring and the tapered inner surface of the outer ring are configured in a manner corresponding to each other,
wherein the outer ring surrounds the inner ring,
wherein the union nut surrounds the outer ring,
wherein the union nut surrounds the threaded piece,
wherein the union nut has an internal thread,
wherein the threaded piece has an external thread, and
wherein the internal thread of the union nut and the external thread of the threaded piece are configured in a manner corresponding to each other.

2. The connecting arrangement of claim 1,
wherein the threaded piece surrounds the outer ring, and
wherein the threaded piece is arranged between the union nut and the outer ring.

3. The connecting arrangement of claim 1,
wherein, during the production of a screw connection to the threaded piece, the union nut moves the outer ring axially along a longitudinal axis in the direction of the threaded piece.

4. The connecting arrangement of claim 1,
wherein the threaded piece has a recess for receiving a securing ring.

5. The connecting arrangement of claim 1,
wherein the outer ring has a first portion and a second portion along a longitudinal axis, and
wherein the threaded piece is arranged in the region of the second portion between the outer ring and the union nut.

6. The connecting arrangement of claim 1,
wherein the union nut has, on the end side, an end portion with a recess,
wherein an inner diameter of the recess of the end portion is smaller than an inner diameter of the internal thread of the union nut,
wherein the outer ring has a first portion, a second portion and a third portion along a longitudinal axis,
wherein, along the longitudinal axis, the first portion lies between the second portion and the third portion, and
wherein the third portion of the outer ring projects beyond the union nut in an axial direction which faces away from the threaded piece.

7. The connecting arrangement of claim 6,
wherein the third portion of the outer ring has a securing ring recess for a securing ring, and
wherein the union nut and the outer ring are secured axially against each other along the longitudinal axis.

8. The connecting arrangement as claimed in claim 1,
wherein the outer ring has a higher modulus of elasticity than the inner ring.

9. The connecting arrangement of claim 1,
wherein the outer ring has a reinforcement.

10. The connecting arrangement of claim 1,
wherein the inner ring and the threaded piece are configured as a single part.

11. The connecting arrangement of claim 1,
wherein the inner ring has a plurality of circumferentially arranged segments which are separated from one another by longitudinal recesses.
